(19) United States
(12) Patent Application Publication
(10) Pub. No.: US 2002/0103810 A1
(43) Pub. Date: Aug. 1, 2002

(54) Dynamic building of applications

(76) Inventors: Kobi Menachemi, Afula (IL); Eran Menachemi, Afula (IL); Eran Lagon, Tel Aviv (IL); Ofir Shachar, Tel Aviv (IL)

Correspondence Address: BROWDY AND NEIMARK, P.L.L.C., 624 Ninth Street, N.W., Washington, DC, 20001, US

(21) Appl. No.: 09/833,738

(22) Filed: Apr. 13, 2001

Related U.S. Application Data
(60) Provisional application No. 60/241,363, filed on Oct. 19, 2000.

(51) Int. Cl. G06F 7/00

(52) U.S. Cl. 707/102

(57) ABSTRACT

A method and system for dynamically building at least part of an application is disclosed. The building in some embodiments includes the provision of new parts of an application. A blueprint document includes at least one specification for building at least part of an application. In certain embodiments, the blueprint document is received via a network. Receiving the document replaces the need to transfer an executable file of the application.

### FIELD OF THE INVENTION

The field of the invention relates to developing applications.

### BACKGROUND OF THE INVENTION

In the prior art, applications (i.e. programs) are written and compiled prior to an executable version of the application being transferred to a user who can run the application. Refer to system 10 of FIG. 1. Programmers write programs in source code (source files 12). The source code has instructions in a particular language such as C. Computers, however, can only execute instructions written in a low level language called machine language. To get from source code to machine language, the programs must be transformed by a compiler. The compiler generates an intermediary form called object code (object files 14). Object code is often the same or similar to a computer's machine language. The final step in producing an executable program 18 is to pass the object code through a linker 16 which combines modules and gives real values to all symbolic addresses therefore producing machine code.

The transfer of the executable program to a user can take place by removable media (i.e. diskette, CD etc.) or over a network. When a new version of the application is introduced, it must again be compiled and an executable program transferred to a user.

Consider, for example, an application that a user downloads from a World Wide Web site. Each time the application is updated, the user must again perform a download of the latest version of the executable program.

Other shortcomings related to the transfer of executable programs include the following: any viruses embedded in the executable program are transferred with the executable program; and depending on the operating system of the receiving computer and possibly other hardware or software constraints, different executable programs need to be transferred.

There are also interpreters which take a source code and interpret the code line by line in run-time.

Object oriented programming is a type of programming in which programmers define objects. Objects include data properties, which may hold information about the object, such as content, visual aspects, communication, etc. Objects also include methods. The methods can operate on the data properties or according to the data properties. A class is a category of objects. The class defines the common properties of the different objects that belong to the class. When an object is instantiated from its corresponding class, a new replica of the class is spawned, resembling the class blueprint. The properties of the new object' may then be changed to contain distinctive data.

One or more classes (sometimes referred to below as “contributing classes”) can be contained within another class (sometimes referred to below as “amalgamated class”) The amalgamated class can also have associated with it new methods, besides the methods associated with the contributing classes.

An application can be thought of as the highest level amalgamated class, composed of application specific classes. When objects are instantiated from classes, whether application specific objects or application level objects, the objects invoke operating system routines (i.e. system calls) to perform the methods.

The above description of how to obtain an object code and the above general overview of object oriented programming are provided in brief for convenience only and are known per se and therefore not detailed.

Refer to FIG. 2 which shows two classes, a list box 20 and a data table 22. List box 20 is a class representing a visual element (i.e. includes visual data) and data table 22 is a class representing a data container (i.e. includes content data). List box 20 is associated with one or more methods, of which “add data” is relevant to the discussion. Data table 22 is also associated with one or more methods, of which “provide data” is relevant to the discussion. An (amalgamated) class 24 is generated by providing a functional link 26 between list box 20 and data table 22 allowing instantiated data table 22 to provide the data which instantiated list box 20 needs. In an address book application, where names are listed in alphabetical order, class 24 can list be, for example, page “P” which includes names and the corresponding addresses and telephone. Due to link 26, class 24 may offer other new methods that list box 20 and data table 22 could not independently offer, for example, adding and displaying a new name.

Note that object oriented programming also suffers from the constraint mentioned above in that new classes including the application class must be generated and compiled so that an executable version of the executable file including the application class is transferred to a user who can run the application.

Prior art US Pat. No. 6,083,276 describes a method and system for creating and configuring an object based application. An application description file is received and parsed. The elements of the parse tree describe objects. The elements are mapped to existing classes or to classes which inherit from existing classes. Objects are then instantiated from the corresponding classes and the application is launched.

There is a need in the art for a method and system for building an application of interest without the accompanying transfer of an executable file of the application. There is also a need in the art for a method and system which allows for the provision of new parts so that an application is not limited to existing parts, either by the creation of new parts and/or by the transfer of new parts.

### SUMMARY OF THE INVENTION

According to the present invention, there is provided a method for building at least part of an application dynamically, including the steps of: providing a document including a specification for building at least part of an application; and building the at least part of an application dynamically using the specification; wherein the at least part of an application is new and the building includes providing the at least part of an application.

According to the present invention, there is further provided, a system for dynamically building at least part of an application, including: a generator for extracting from a document a specification for building at least part of an application; and a loader for dynamically building the at least part of an application based on the specification, wherein the at least part of an application is new and said building includes providing said at least part of an application.

According to the present invention, there is further provided a method for building an application of interest, including the steps of: receiving a document including a specification for at least part of an application, over a network; and building the application of interest; wherein the document allows the application of interest to be built without the transfer of an executable file of the application of interest over the network.

According to the present invention, there is further provided a program storage device readable by machine, tangibly embodying a program of instructions executable by the machine to perform method steps for building at least part of an application dynamically, including the steps of: providing a document including a specification for building at least part of an application; and building the at least part of an application dynamically using the specification; wherein the at least part of an application is new and the building includes providing the at least part of an application.

According to the present invention, there is further provided a computer program product comprising a computer useable medium having computer readable program code embodied therein for building at least part of an application dynamically, the computer program product including: computer readable program code for causing the computer to provide a document including a specification for building at least part of an application; and computer readable program code for causing the computer to build the at least part of an application dynamically using the specification; wherein the at least part of an application is new and the building includes providing the at least part of an application.

According to the present invention, there is further provided a program storage device readable by machine, tangibly embodying a program of instructions executable by the machine to perform method steps for building an application of interest, comprising the steps of: receiving a document including a specification for at least part of an application, over a network; and building the application of interest; wherein the document allows the application of interest to be built without the transfer of an executable file of the application of interest over the network.

According to the present invention, there is further provided a computer program product comprising a computer useable medium having computer readable program code embodied therein for building an application of interest, the computer program product including: computer readable program code for causing the computer to receive a document including a specification for at least part of an application, over a network; and computer readable program code for causing the computer to build the application of interest; wherein the document allows the application of interest to be built without the transfer of an executable file of the application of interest over the network.

### BRIEF DESCRIPTION OF THE DRAWINGS

The invention is herein described, by way of example only, with reference to the accompanying drawings, wherein:

FIG. 1 is a prior art system for developing computer programs;

FIG. 2 is prior art class containing two other classes;

FIG. 3 is an illustration of a blueprint document used to dynamically build at least part of an application according to an embodiment of the current invention;

FIG. 4 illustrates the relationship between different descriptor types according to an embodiment of the current invention;

FIG. 5 illustrates an example of an amalgamated class according to an embodiment of the current invention;

FIG. 6 is a system for building applications dynamically according to an embodiment of the current invention;

FIG. 7 is a flowchart of an object oriented method of building, according to an embodiment of the current invention;

FIG. 8 illustrates the loading of the class of FIG. 5 using the system of FIG. 6, according to an embodiment of the current invention;

FIG. 9 illustrates the downloading of a class according to an embodiment of the current invention;

FIG. 10 is a flowchart of the process of generating a class according to an embodiment of the current invention;

FIG. 11 illustrates an example of two objects contained in an application, according to an embodiment of the current invention;

FIG. 12 illustrates the generation of a GUI element according to an embodiment of the current invention;

FIG. 13 is a flowchart of the instantiation and initialization process, according to an embodiment of the current invention;

FIG. 14 is a flowchart of the invoking of methods process, according to an embodiment of the current invention; and

FIG. 15 illustrates a network for transmitting a blueprint document according to an embodiment of the current invention.

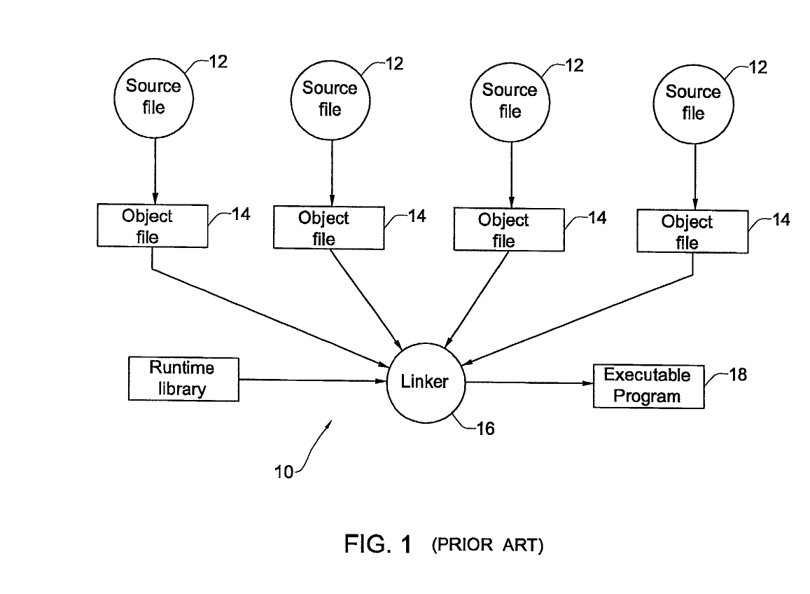

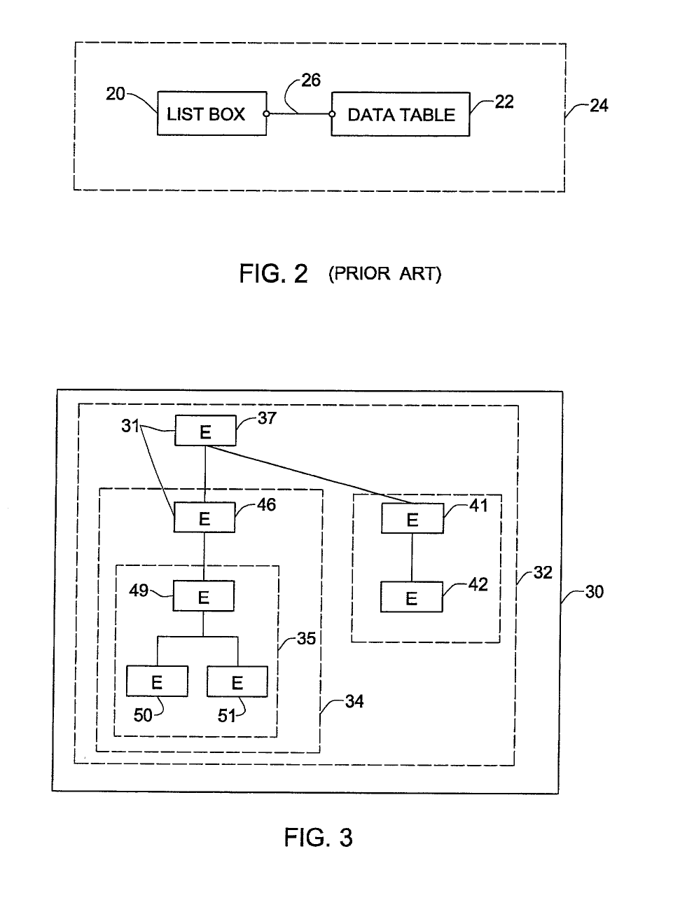

### DESCRIPTION OF THE PREFERRED EMBODIMENTS

A preferred embodiment of the invention relates to a system and method for building at least part of an application during run time (i.e. dynamically). The system and method of the preferred embodiment of the present invention are particularly useful for applications that are transferred over a network. The principles and operation of a system and method for building applications dynamically according to a preferred embodiment of the present invention may be better understood with reference to the drawings and the accompanying description. In the sense of the current invention, building (parts or applications) includes the usage of existing parts (i.e. locally available parts), the derivation of parts from other parts (for example through inheriting from other parts, or amalgamating parts, without the addition of new properties and/or methods to the derived parts), the provision of new (i.e. locally unavailable/non-existing) parts; and/or the configuration of parts to form particularized parts. The provision of new parts includes creating new parts and/or receiving from a remote location new parts. A created part may or may not inherit from another part (“parent part”), or may or may not include other contributing parts of the application, but in any event, the created part will also include properties and/or methods not included in the parent part, if any, or the other contributing parts, if any.

As an example, in object oriented programming, building including loading existing (locally available) classes, deriving classes from other classes for example through inheritance or amalgamation (without the addition of new properties/methods), providing new (i.e. locally unavailable/non-existing) classes, and/or instantiation and property manipulation of instantiated objects from classes. Providing new classes includes for example generating new classes and/or downloading new classes from a remote location. The generated class may or may not inherit from a parent class, or may or may not include other contributing classes, but in any event, the generated class will also include property descriptors and/or method descriptors not included in the parent class, if any, or other contributing classes, if any.

By allowing the creation of new parts of an application and/or the downloading of new parts an application of interest can be built which is not bound by existing parts (i.e. parts locally available) or derivations thereof.

Referring now to the drawings, FIG. 3 illustrates a document 30 which functions as a blueprint (i.e. provides specifications) for building at least part of an application. Preferably, document 30 is written in semi-structured data textual protocol. An example of the textual protocol is an XML instant of a markup language, however it should be evident that document 30 can be written in any language that allows document 30 to convey a blueprint for building at least part of an application. Document 30 that functions as a blueprint replaces the need for providing an executable file of the whole application. Document 30 can be parsed into a parse tree including one or more (nodes) elements 31. An element is the basic data entity of a semi-structured data document and may contain one or more attributes to further describe the element. One or more elements 31 form a specification for building at least part of an application i.e. “descriptor” 32.

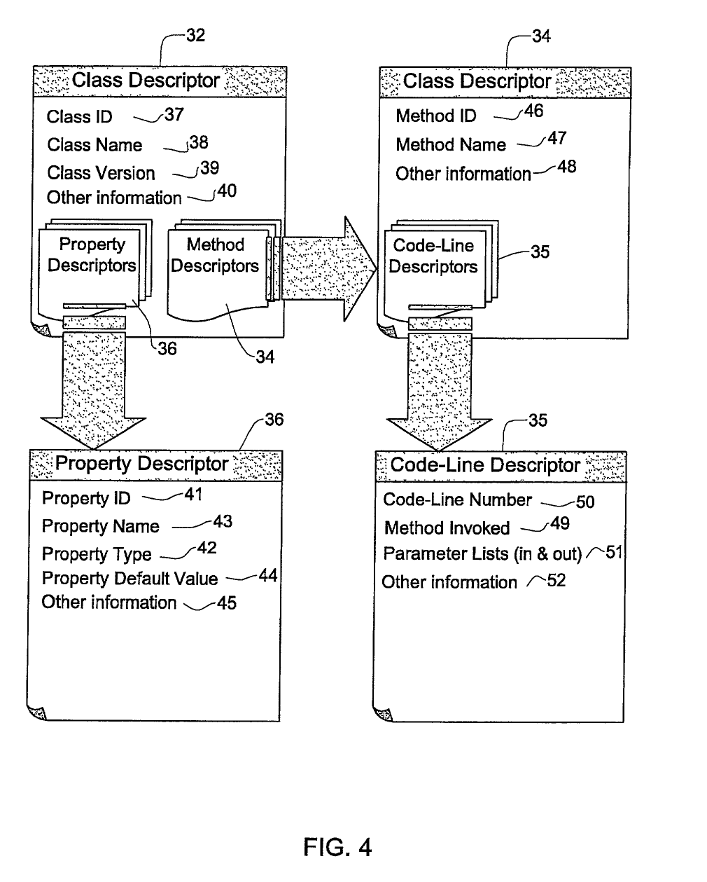

For example, referring to both FIGS. 3 and 4, in an object oriented programming implementation, assume that each descriptor 32 is a class descriptor which describes a class. In one embodiment of the invention each class descriptor 32 includes a class ID 37 and optionally a class name 38, a class version 39, and other information on the class (for example if the class has a parent) 40. Preferably, class ID 37, class name 38 (when used), class version 39 (when used), and other information 40 (when used) are each included in one or more separate elements 31 forming class descriptor 32, however those skilled in the art will realize that class ID 37, class name 38 (when used), class version 39 (when used), and other information 40 (when used) may be combined into fewer elements 31.

In one embodiment of the invention, each class descriptor 32 optionally includes one or more method descriptors 34 (sometimes referred to below as “instructions 34”) and one or more property descriptors 36 (sometimes referred to below as “tagged data 36”). In one embodiment of the invention, each property descriptor 36 includes a property ID 41, and a property type 42, and optionally a property name 43, property default values 44 and other information on the property 45. Preferably, property ID 41, property type 42, property name (when used) 43, property default values 44 (when used), and other information (when used) 45 are each included in one or more separate elements 31 forming property descriptor 36, however those skilled in the art will realize that property ID 41, property type 42, property name (when used) 43, property default values 44 (when used) and other information 45 (when used) may be combined into fewer elements 31.

In one embodiment of the invention, each method descriptor 34 includes a method ID 46 and optionally a method name 47 and other information 48. Preferably, method ID 46, method name 47 (when used) and other information 48 (when used) are each included in one or more separate elements 31 forming method descriptor 34, however those skilled in the art will realize that method ID 46, method name 47 (when used) and other information 48 may be combined into fewer elements 41. In one embodiment of the invention, each included method descriptor 34 includes one or more code line descriptors 35.

In one embodiment of the invention, each code line descriptor 35 includes a method invoked 49, a code line number 50, parameter lists (in and out) 51 and optionally other information on the code line 52. Preferably method invoked 49, code line number 50, parameter lists (in and out) 51 and other information 52 (when used) are each included in one or more separate elements, however those skilled in the art will realize that method invoked 49, code line number 50, parameter lists (in and out) 51 and other information 52 (when used) can be combined into fewer elements 31. FIG. 4 illustrates the relationships between class descriptors 32, property descriptors 36, method descriptors 34 and code line descriptors 35.

More generally, method descriptors i.e. instructions 34 describe the methods that can be performed by or on an instantiated object of a class. Property descriptors i.e. tagged data 36 describe the content related to an instantiated object of a class. In addition, property descriptors 36 of a specific class descriptor 32 related to a specific amalgamated class may specify when applicable one or more contributing classes and the class descriptors of these contributing classes which are contained in the specific class.

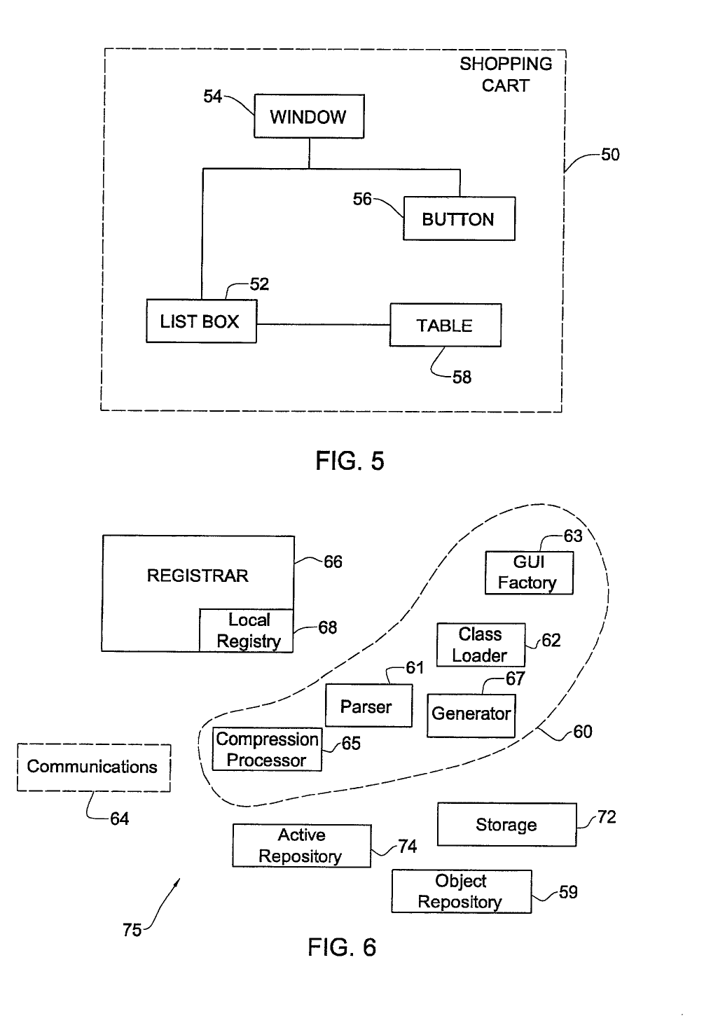

As an example, FIG. 5 shows a shopping cart class 50 that contains three visual contributing classes: a window class 54, an “add” button class 56, and a list box class 52. In addition, shopping cart class 50 also contains one collection class, a table class 58. Instructions 34 for shopping cart 40 includes the method “add an item to shopping cart by pressing the button”. Tagged data 36 for shopping cart 50 when 20 instantiated, may include items, prices and origination store for items already in shopping cart 50 such as “soap a, $0.99, xdrugstore, shampoo b, $2.50, ydrugstore”. Tagged data 36 may also include “window 54 is 100 pixels down”, “button 56 is 5 pixels down from the top of window 54”; “list box 52 has three columns of 15 pixels width each”; “table 58 includes three columns for item names, prices and origination store”.

FIG. 6 illustrates an embodiment of a system 75 which uses document 30 as a blueprint for building at least part of an application. System 75 includes a runtime engine 60, which provides the necessary services to create and execute a dynamic application. Runtime engine 60 includes an optional compression processor 65, a parser 61, class descriptor generator 67, a class loader (sometimes referred to below as “builder”) 62 and an optional GUI factory 63. Parser 61 and generator 67 are sometimes referred to below as “kernel”.

System 75 may also include a local storage 72 (sometimes referred to below as “extended library 72”) such as a hard drive, a registrar 66 with a local registry 68, and active class repository 74.

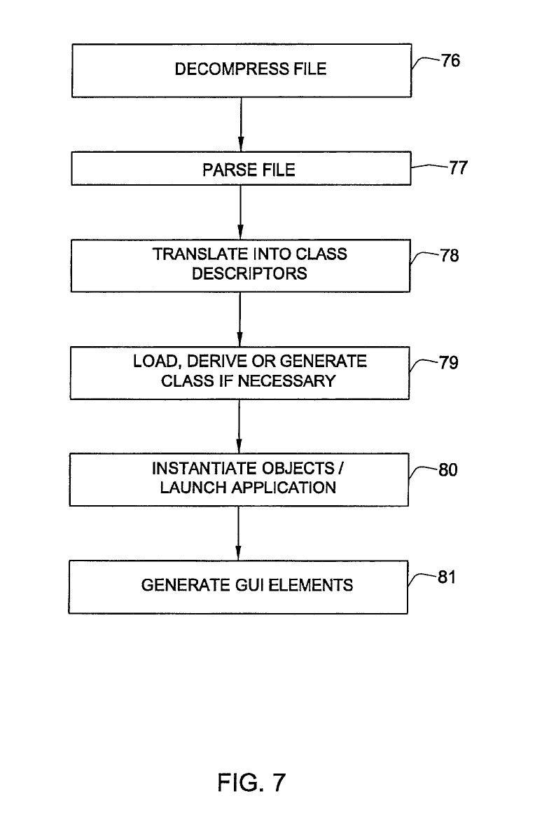

Refer to FIG. 7 which shows an object oriented method of building, according to an embodiment of the current invention. If document 30 is compressed, then the first step is for compression processor 65 to decompress document 30 (optional step 76). Parser 61 parses document 30 in step 77. In certain embodiments of the current invention, the output of parser 61 is a DOM tree including elements 31. An example of parser 61 which can be used for the invention is MSXML, created by Microsoft and available on Internet Explorer version 4.0 and up.

Class descriptor generator 67 translates the parsed document (which in certain embodiments is in the form of a DOM tree) into one or more class descriptors 32 in step 78. Class descriptor generator 67 recognizes a set of DOM elements 31 that logically belong to one class descriptor 32. Generator 67 inserts the content contained within these elements 31 into a new class descriptor structure. Class descriptors 32 in certain embodiments describe classes to be generated, derived or classes to be loaded (which in the context of the method of FIG. 7 may or may not involve downloading). Classes which were previously generated, derived or loaded or classes which were pre-loaded are already stored in an active class repository 74. Class loader 62 receives any requests to load, derive or generate classes according to class descriptor 32 and either loads, derives, or generates the class in step 79. The loaded derived and/or generated classes are then stored in active class repository 74. Instantiation of objects from one or more generated, loaded derived or preloaded classes may occur prior to and/or subsequent to the launch of the application (step 80) If desired, optional GUI Factory 63 generates GUI elements from the instantiated objects that can be graphically displayed to a user in optional step 81.

In certain embodiments, optional GUI factory 53 receives instructions 34 and translates “universal” (not dependent on operating system) instructions 34 to system call(s) specific to a particular operating system. Reference is made to Win32 API calls in msdn.microsoft.com. In other embodiments, document 30 includes operating-system specific instructions 34.

In certain embodiments, local storage 72 provides those application parts which are considered desirable to be accessible for easy loading and/or some or all of the parts which can not be created or derived from other parts. For example, in object oriented programming, storage 72 may include the most frequently used classes for building applications. In other embodiments, some application parts such as those most frequently used are already pre-loaded (for example classes in object oriented programming into active class repository 74). In other embodiments, no application parts are provided by local storage 72 or preloaded, and application parts (for example the classes in object oriented programming) are created or downloaded from a remote location as needed.

Local registry 68 stores information about each application part provided by storage 72 in a way that allows class loader 62 to retrieve the application part quickly. For example, in object oriented programming, registry 58 stores information about classes provided by storage 72.

In some embodiments, local registry 68 stores information about previously generated parts, whose descriptors 32 are stored in storage 72. For example, in object oriented programming, full versions of class descriptors 32 of previously generated classes may be stored in storage 72.

Optionally, local registry 68 or another memory location, may also store general information regarding the application so as to maintain continuity between sessions. Optionally, local registry 68 or another memory location may also store a user profile (i.e. user information, preferences personalized details, etc.) and/or device details. The user profile could include for example accessibility options (e.g. if the user is near sighted sited, the display would use larger icons and fonts), level of use (simple or advanced), age category (i.e. a display geared to a child or an adult), etc. The device profile's preferences can include, display area (e.g. portrait, low resolution, grayscale, etc.), bandwidth (mobile devices sometimes have lower bandwidth than stationary workstations), processing capabilities etc.

In certain embodiments, the user profile and/or device profile are reflected in document 30, i.e. document 30 is adjusted to take into account the user profile and/or device profile. In other embodiments, the user profile and/or device profile affect the running of part or all of an application, i.e. document 30 is standard but runtime engine 60 creates and executes part or all of an application based on document 30 differently depending on the user profile and/or device profile. In other embodiments, the user profile and/or device profile have no impact on document 30 or the creation and execution of part or all of application based on document 30.

Local registry 68 can be, for example in the form of a tree-sorted data base.

Registrar 66 manages local registry 68. Management of local registry 68 may include one or more of the following tasks. First, during idle time (i.e. when registrar 66 is not otherwise busy), registrar 66 may remove information about application parts (for example classes in object oriented programming) which have not been used for a long period of time from registry 68. By removing the information from registry 68, registrar 66 also enables overwriting of the actual application parts (for example classes in object oriented programming) provided by storage 72. Second, registrar 66 may compare the most recent versions of application parts available with those stored in registry 68 and upgrade the versions of the application parts (for example classes in object oriented programming) if necessary. The comparison and upgrade can be performed during idle time or upon demand for a specific application part. In alternative embodiments, an overall comparison and upgrade of all application parts can be requested. Registrar 66 may also keep a record of previous versions to enable backward support (i.e. support of the previous versions).

In certain embodiments of the present invention, preloaded classes, classes loaded from local storage 72, and/or downloaded classes are in executable form and therefore the corresponding class descriptors 32 may not include any method descriptors 34 or code line descriptors 35.

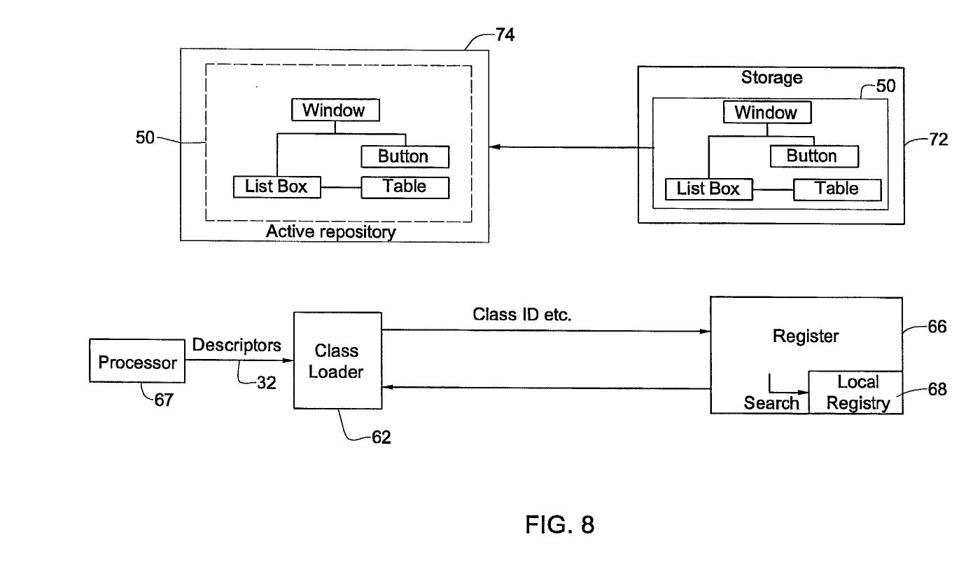

Reverting now to the example of shopping cart 50, and referring to the embodiment illustrated in FIG. 8, class descriptor generator 67 transfers descriptor 32 to class loader 62. Class loader 62 first looks in active class repository 74 for shopping cart class 50. If shopping cart class 50 is not in active class repository 76, shopping cart class 50 needs to be loaded (which may include downloading), derived or generated. In one embodiment of the invention, the information on whether shopping cart class 50 needs to be loaded (which may include downloading) or derived/generated is included in class descriptor 32. One element of class descriptor 32 mentions whether class 50 is binary (executable and thus should be loaded or downloaded) or dynamic (thus should be generated/derived).

Assume shopping cart 50 needs to be loaded (which may include downloading). Class loader 62 transfers a request for shopping cart 50 to registrar 66 which searches registry 68 for shopping cart 50. Preferably the search is conducted using class ID 37 and optionally class version 39 from class descriptor 32 for shopping cart 50. If the class for shopping cart 50 is registered (and optionally class version 39 is also correct), then class loader 62 loads the existing class for shopping cart 50 from storage 72 into active class repository 74. If the class for shopping cart 50 is not registered (or optionally class version 39 is incorrect), downloading from a remote location is required, either by communication link 64 (FIG. 5) or by some other means of transfer (diskette, CD, etc).

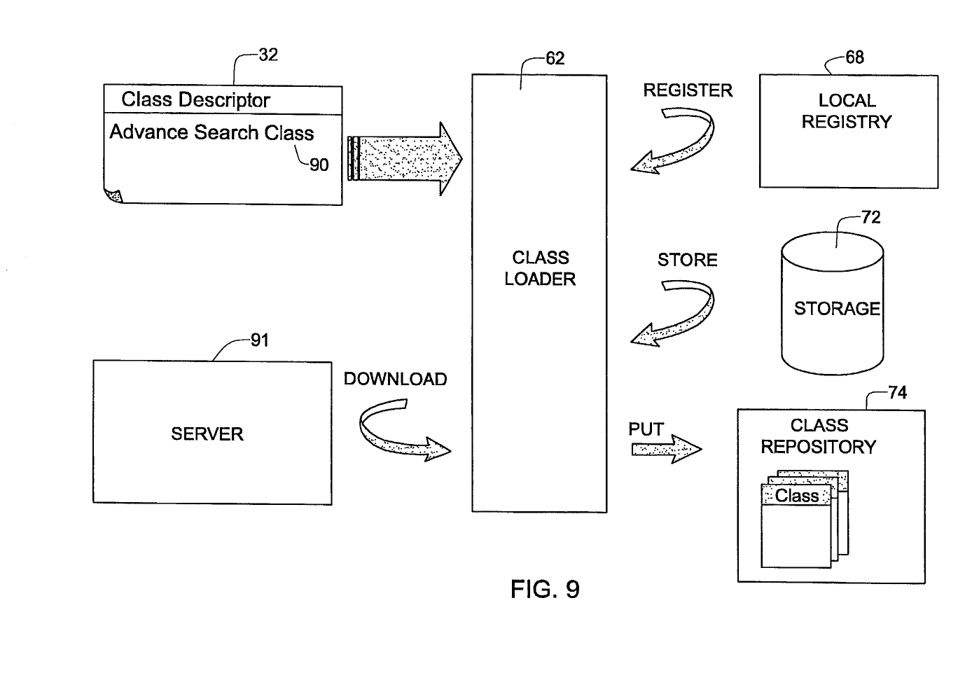

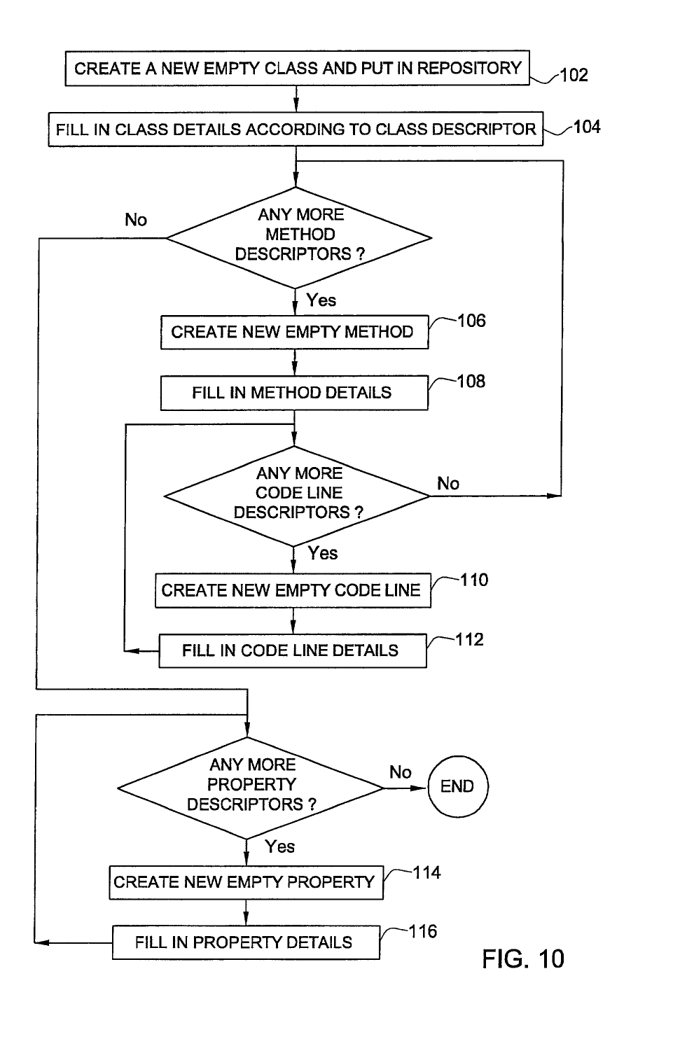

FIGS. 9 illustrates one embodiment of the process for downloading from a remote location using as an example another class 90.

Assume for the sake of example that an advance search function is not initially allowed for shopping cart 50. An advance search function allows a user to specify more than one parameter for a search. By this example, parameters could include among others, types of products (for example, drugstore items), prices (for example, items costing more than $2), date bought (for example, this past week). Class 90, which when added to shopping cart class 50 allows advance search functionality in a more complex shopping cart class is assumed to not be in storage 72, perhaps because advance searches are performed rarely and so storing is not worth it. Another reason for downloading in some embodiments could be because only an older version of the class is stored in storage 72. In preferred embodiments, it is also assumed that class 90 is a basic part (i.e. a part that can not be generated or derived from other parts). Class 90 is therefore downloaded, registered in registry 68, placed in storage 72, and loaded into active class repository 74. In other embodiments, registration can occur after placement in storage 72 or loading in repository 74. In other embodiments, class 90 is downloaded directly into repository 74.

In some embodiments, the remote downloading of class 70 process is triggered by a user (for example, by adding an item to shopping cart class 50, by specifically requesting an advance search etc). Alternatively, remote downloading may be performed during idle time.

Class descriptor 32 for advance search class 90 may include the information that the advance search class 90 is not in storage 72 and may include one or more locations from where class 90 may be remotely downloaded. Alternatively, a default location for classes to be remotely downloaded may be known to system 75. In another embodiment, descriptor 32 does not include the information that class 90 is not in storage 72 but includes one or more locations from where class 90 can be downloaded if necessary, and similarly to FIG. 8, registrar 66 searches local registry 68 for class 90 and does not find a match. In this way system 65 is informed of the need to remotely download class 90.

In certain embodiments, class loader 62 downloads class 90 from a remote location 91, for example, one of a plurality of download servers, using communication link 64. The requested class 90 is identified to remote location 91, for example, by class identifier 37 for class 90 and optionally class version 39 for class 90. Class loader 62 puts class 90 in active class repository 74. If it is desired to store class 90 in local storage for subsequent access, class 90 is also stored in storage 72 and registered in local registry 68.

FIG. 10 illustrates a process for generating a class, according to an embodiment of the present invention using as an example another class 100 (not shown).

For example, assume shopping cart class 50 is contained in a shopping class 100 which allows “shopping i.e., selecting items on store shelves, and placing the items in the shopping cart”. In order to generate shopping class 100, class loader 62 creates a new (empty) class 100 and puts class 100 in class repository 74 in step 102. Class loader 62 then fills in class details into (empty) class 100, according to class descriptor 32 in step 104. Class details can include one or more of the following: class ID 37, class name 38, class version 39, and other class information 40.

For each method descriptor 34 included in class descriptor 32, class loader 62 creates a new (empty) method and puts the new (empty) method in the method list (i.e. collection of methods) of class 100 in step 106. Class loader 62 fills in the method details into the empty method according to method descriptor 34 in step 108. Method details can include one or more of the following: method ID 46, method name 47, other information 48. For each code line descriptor 35 included inside method descriptor 34, class loader 62 creates a new (empty) code line and puts the new (empty) code line into the code line list (i.e. collection of code lines) of the method in step 110. Class loader 62 fills in the code line details according to code line descriptor in step 112. Code line details can include one or more of the following: method invoked 49, code line number 50, parameter lists (in and out) 51, and other information 52.

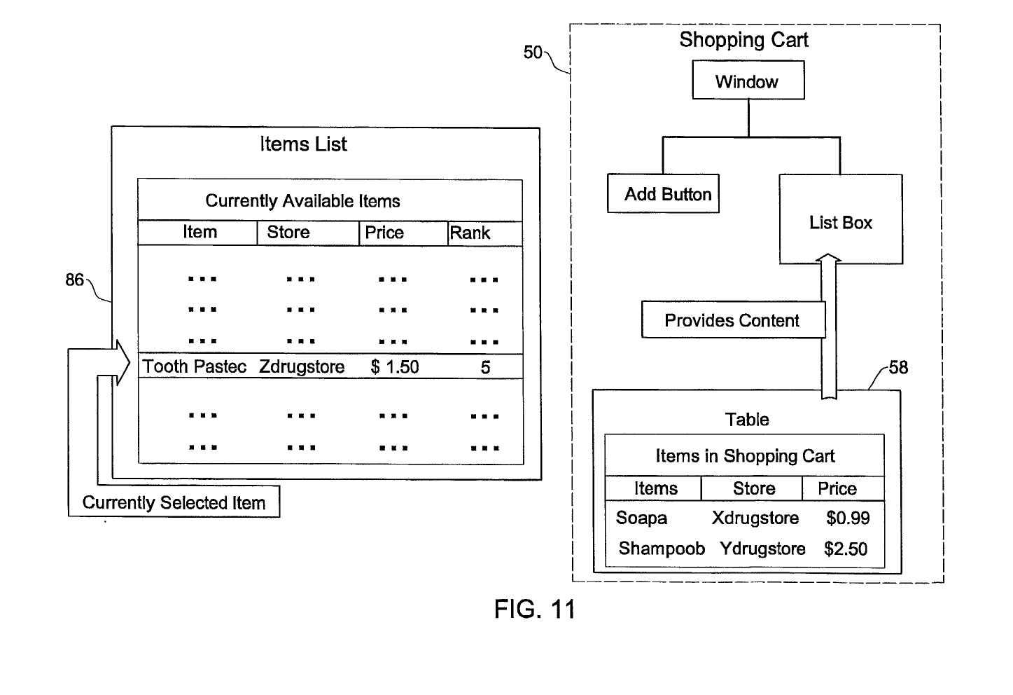

For each property descriptor 36 included inside class descriptor 32, class loader 62 creates a (new) empty property and puts the (empty) property in the property list (i.e. collection of properties) in step 114. Class loader 62 fills in the property details into the empty property according to property descriptor 36 in step 116. Property details can include one or more of the following: property ID 41, property type 42, property name 43, property default values 44, and other information 45. As mentioned above, properties may also describe contributing classes, for example by including in addition to the regular fields the class descriptors of the contributing classes. For example, one of the properties of class 100 may be that class 100 includes cart class 50 and a second class 86 (see FIG. 11) which has an associated method of “select an item from a shelf by clicking on item”.

The above description of the method of generating a class is an example only, and generation of a class in other embodiments may be realized through alternative methods.

In some embodiments, the created application part is automatically registered in registry 78 prior to or subsequent to creation so that class loader 62 can load from storage 72 the class descriptor 32 of the created part again if necessary. For example, in object oriented programming, the generated class is registered in registry 68. In alternative embodiments, no registration of created application parts takes place and class loader 62 each time creates a certain application part as if it were the first time.

In some embodiments of the invention, document 30 initially includes a condensed version of class descriptor 32 for each class to be generated in addition to a reference to one or more locations from where the full class descriptor 32 can be downloaded. Class loader 62 uses the condensed version of the class descriptor 32 to check if the class is registered. If the class is registered, the full class descriptor 32 is loaded from storage 72 otherwise the full class descriptor is downloaded from one of the locations of reference.

Class descriptors 32 for derived classes generally include the parent class (if any) and property descriptors 36 which describe the contributing classes (if any), besides the usual elements such as class ID 37. Generally no additional property descriptors 36 and no method descriptors 34 are needed because no additional properties and/or methods are included in derived classes.

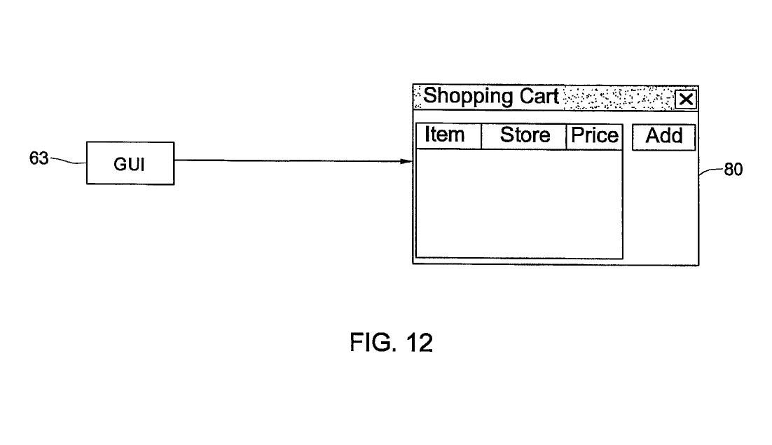

In FIG. 12, the logic representation of a class is optionally used by GUI factory 63 to generate a GUI element 80. Reference for a factory design pattern is hi made to—Design Patterns by Gamma, Helm, Johnson, Vlissides (Addison Wesley), FACTORY METHOD p. 107.

Typically, the top level application part (for example application class in object oriented programming) is the complete application. In certain embodiments of the invention, an application object is instantiated from the application class. In order to initialize the application, runtime engine 60 invokes the initialize method of the application object. After the application is initialized, runtime engine 60 invokes the run method of the application object. The application runs until terminated. Before the application has terminated, runtime engine 60 invokes the terminate method of the application object, thereby reinitializing the application and in some embodiments clearing active repository 74 and an object repository 59 (FIG. 6).

Assume for example that shopping class 100 is an application class. The method “run” may for example trigger an immediate function of “wait for user input”. Refer back to FIG. 11. Items on the shelf are listed in an “items list”” 86. Once a user selects an item from items list 86, and presses add button 56, runtime engine 60 begins to perform a series of other methods, for example getting the currently selected item from instantiated items list 86, adding the selected item to instantiated shopping cart table 58, and refreshing the display.

In some embodiments of the invention, a description of the application class is not received in document 30 and no application class is necessary. The application is invoked immediately after all classes have been loaded or generated so as to launch the application.

As mentioned above, instantiation of objects may occur prior to or subsequent to the launching of the application. In certain embodiments, instantiation of some objects may occur prior and instantiation of some objects subsequent to the application launching. In certain embodiments, instantiation of some or all objects may be automatic and in some embodiments instantiation of some or all objects may only occur when necessary. In some embodiments, instantiation of some or all objects may never occur.

After instantiating objects from classes, for example shopping cart class 50, advance search class 90, or shopping class 100, runtime engine 60 is able to perform a configuration process to render shopping cart 50, advance search 90, or shopping class 100 suitable for a particular application. The configuration process refers to property manipulation i.e. setting values to properties of the instantiated object. As mentioned above, such a configuration process is also considered building in the context of this invention.

To instantiate a class, runtime engine 60 creates a new object in object repository 59 (FIG. 6) and associates the object with the instantiated class. Along with the new object, the properties of the object are created automatically according to the property descriptors of the class. If one or more of the property descriptors refer to another class, the runtime engine will create an object for the contributing class to serve the property of the amalgamating object. In some embodiments, this process goes on recursively.

Later during the running sequence of the application, the methods of the class in some embodiments are invoked by: obtaining a reference to the object from the object repository, finding the required method inside the class associated with the object, and invoking the required method. Also, during the course of the application, special methods may be invoked to get the properties or set the values of the properties of the object. This way of invoking methods can be used in these embodiments for all types of classes.

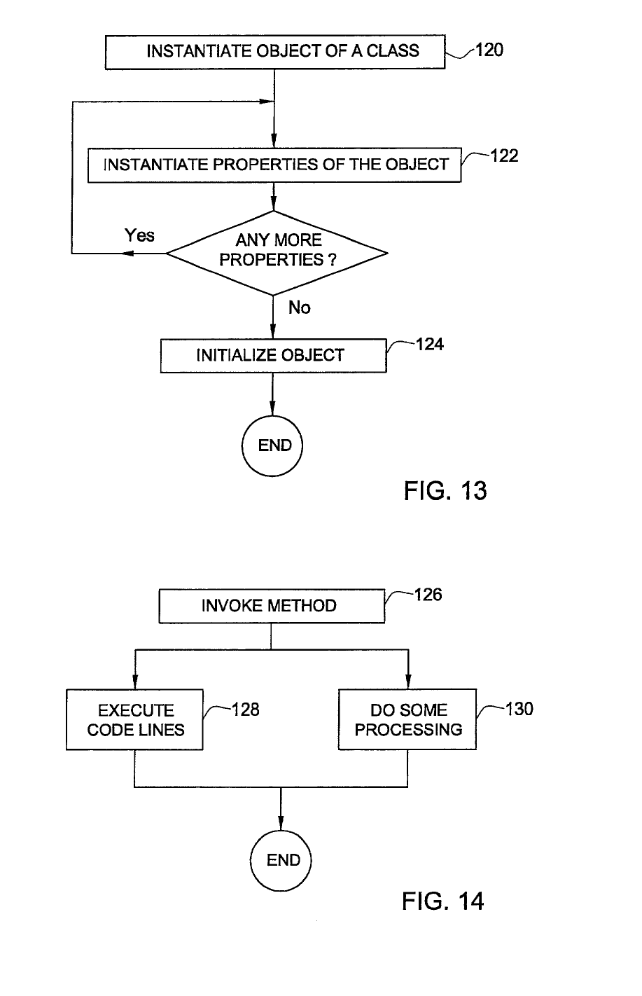

Refer to FIG. 13, which illustrates the instantiation and initialization of an object, according to an embodiment of the invention. In certain embodiments of the present invention, when an object of a class is instantiated (step 120), automatically all of the properties of the object are instantiated as well (step 122) The object is then initialized (step 124) by invoking a default object initialization method.

Refer to FIG. 14 which illustrates the invoking of a method, according to an embodiment of the invention. The first step is the invoking of a method of an object (step 126). Generated methods, if not empty, are composed of code lines. Loaded (including downloaded) methods include executable code to be executed by the central processing unit. When a method is invoked, each code line (if any) is executed in turn (step 128). The code line in some embodiments is another method call so that the execution of the code line invokes another method. For methods including executable code, the invoking of the method results in a specific processing operation (step 130)

In certain embodiments, the invoking of methods is performed on demand. Each method of a class may be invoked individually.

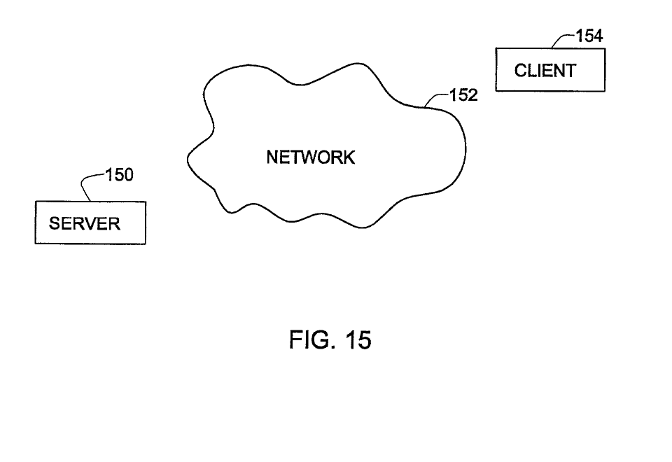

Refer to FIG. 15. In certain embodiments of the present invention, document 30 is received by a client 154 (sometimes called “the player”, a software preinstalled on the user's computer) from one or more network servers 150 through communication 64 (FIG. 6). The usage of document 30 allows a transfer of an application or part of an application without transferring an executable file of the application (i.e. without transferring a full application which has been compiled into an executable program)

As mentioned above, an important feature of the present invention is that virtually any application of interest can be built on client 154 without transferring an executable file of the application. In the prior art, applications that could be built were limited by the parts pre-installed on a client. Therefore many applications of interest could not be built using the methods of the prior art. The embodiments of the present invention, however, allow the creation of new parts and/or the downloading of new parts which increases the flexibility of applications.

Even in the event where transfer of executables for parts of an application is desirable (for example by downloading a part which is new (i.e. not locally available) and can not be generated or derived from other parts such as a new version of an existing part), there are advantages to transferring executables for parts of an application rather than an executable file of the application. First, executables for parts of an application (for example classes) form less bulk than an executable file of the entire application, allowing faster transfer and less network loading. Second, the executable parts (for example classes) may be reused for more than one application. Therefore sending one executable class may replace the need to transfer more than one application.

In certain embodiments of the invention, no (accompanying) executables need to be transmitted over a network 152 to build an application of interest. In other embodiments, some (accompanying) executables for parts are transmitted over network 152 (for example during downloading of classes) in addition to the specifications for those parts. Preferably, however in these embodiments, transmission over network 152 of the specifications (for example for parts that are locally loaded, derived or generated) suffices for most parts of the application. In some cases, the executables transmitted are for new parts (i.e. not locally available) that are basic (i.e. can not be created or derived from other parts), for example a rarely used basic part or a new version of an existing basic part. In preferred embodiments of the invention, most of the basic parts (classes in object oriented programming) are initially contained in the player, pre-installed on a user's computer during a set-up phase (i.e. in storage 72 and available for subsequent loading), so that after the initial installation, most new parts (classes) can be generated without the additional transfer of executables for downloaded parts (classes). In these preferred embodiments, the application can be built with insignificant accompanying transfer over the network of executables for parts.

FIG. 15 shows a network server 150 connected through network 152 to a client 154. The network can be the Internet, a local area network, a wireless network, cable, satellite-dish network, any client-server platform etc. The protocol used can be, for example TCP/IP, GSM, CDMA, TDMA, etc.

Server 150 can provide to client 84 the version updates, and/or downloaded classes mentioned above. In certain embodiments of the present invention, some or all classes provided by storage 72 are received during the first connection of client 84 to network server 81.

In certain embodiments, the user profile and/or device profile described above are communicated to server 150 each time client 154 connects to server 150. In certain embodiments, server 150 selects an appropriate document 30 (for example a semi-structured document in an XML form) or causes a standard document 30 to be varied based on the user profile and/or device profile. In other embodiments, server 150 may transmit a standard document 30 regardless of the user profile and/or device preference. Above, it was mentioned that active class repository 74 holds currently active classes and optionally pre-loaded classes. In network embodiments, classes may be considered no longer active once a session is over, i.e. after disconnecting from network server 150 and/or moving to a different web site.

Preferably, client 154 communicates with server 150 during run time. The communication can include content or data requests, application management and session information.

Reverting to the example of shopping cart class 50, when instantiating an object from shopping cart class 50, client 154 may request from server 150 updated prices for items remaining in instantiated object of shopping cart 50 from a previous network connection.

Application management includes version updates, login/logoff events, etc. Session information and current state may be provided by client 154 to server 150 in order that server 150 can involve one or more other clients 154 in the same session (for example where two or more user compete and the server mediates).

Methods on or by application parts and/or complete applications (for example in object oriented programming instantiated objects of classes including possibly the application class) may be performed locally (on client 154) or with the help of server 150. For example the advance search method mentioned above may be performed locally if all data is available on client 154. A check out method for items in instantiated object of shopping cart 50 on the other hand may need to be performed in conjunction with server 150 if client 154 needs to receive approval of credit card, and/or information regarding inventory, shipping time, etc.

In order to further clarify a preferred embodiment of the present invention, a non limiting example is presented below which describes shows one embodiment the process for building an application with reference to the contents of a specific document 30 shown below. The example assumes that communications link 64 is present and that document 30 is written in OAML (online application markup language). OAML is an example of an XML based markup language. A well formed OAML document (or collection of documents) includes a complete set of instructions and configurations to create a fully working online application.

The application allows the receiving of data by client 154 from server 150; the insertion of data into a local table; the sorting of the table according to a specific field; and the transmitting of the sorted table by client 154 to server 150.

Document 30 is shown below

Class Descriptor:

Name: Table
Type: Loaded
ID: 01234

Class Descriptor:

Name: My Table
Type: Generated
ID: 01235
Parent Table
Method Descriptor:

Name: Init Table Fields
ID: 1
Code Line Descriptor:

Number: 1
Method: Set Field
Parameter 1: 1
Parameter 2: Title

Code Line Descriptor:

Number: 2
Method: Set Field
Parameter 1: 2
Parameter 2: Price

Code Line Descriptor:

Number: 3
Method: Set Field
Parameter 1: 3
Parameter 2: Author

Class Descriptor:

Name: My Application
Type: Generated
ID: 01237
Property Descriptor:

Name: Books Table
Type: My Table

Method Descriptor:

Name: Run
ID: 1
Code Line Descriptor:

Number: 1
Method: Init Table Fields
Parameter 1: Books Table

Code Line Descriptor:

Number: 2
Method: Get Data From Server
Parameter 1: www.xyz.com/getdata%books
Parameter 2: Books Table

Code Line Descriptor:

Number: 3
Method: Sort Table By Field
Parameter 1: Books Table
Parameter 2: 2

Code Line Descriptor:

Number: 4
Method: Send Data To Server
Parameter 1: www.xyz.com/setdata%books
Parameter 2: Books Table

Document 30 includes three class descriptors 32: one loaded and two generated. The loaded class is “Table” which is replicated below:

Class Descriptor:

Name: Table
Type: Loaded
ID: 01234

Runtime engine 60 identifies that this class descriptor 32 is to be loaded by the Type attribute, and loads the class into active class repository 74.

In this example the loaded class is an executable that exists on client 154 and is loaded from storage 72.

The two generated classes are called “My Application” and “My Table” and are replicated below

Class Descriptor:

Name: My Table
Type: Generated
ID: 01235
Parent: Table
Method Descriptor:

Name: Init Table Fields
ID: 1
Code Line Descriptor:

Number: 1
Method: Set Field
Parameter 1: 1
Parameter 2: Title

Code Line Descriptor:

Number: 2
Method: Set Field
Parameter 1: 2
Parameter 2: Price

Code Line Descriptor:

Number: 3
Method: Set Field
Parameter 1: 3
Parameter 2: Author

Class Descriptor:

Name: My Application
Type: Generated
ID: 01237
Property Descriptor:

Name: Books Table
Type: My Table

Method Descriptor:

Name: Run
ID: 1
Code Line Descriptor:

Number: 1
Method: Init Table Fields
Parameter 1: Books Table

Code Line Descriptor:

Number: 2
Method: Get Data From Server
Parameter 1: www.xyz.com/getdata%books
Parameter 2: Books Table

Code Line Descriptor:

Number: 3
Method: Sort Table By Field
Parameter 1: Books Table
Parameter 2: 2

Code Line Descriptor:

Number: 4
Method: Send Data To Server
Parameter 1: www.xyz.com/setdata%books
Parameter 2: Books Table

The first important attribute of the “My Table” generated class is that it has a parent. This attribute is optional, and means that the class inherits the behavior of the parent, and may add new properties and methods of its own.

Class descriptor 32 for “My Table” states that the new generated “My Table” class inherits behavior from the loaded parent “Table” class. This means that the “My Table” class is actually a Table, but with a special setup. The difference between “My Table” and “Table” is that “My Table” adds a new method named “Init Table Fields” (i.e. initialize table fields).

Below is method descriptor 34 for the method “Init Table Field”:

Method Descriptor:

Name: Init Table Fields
ID: 1
Code Line Descriptor:

Number: 1
Method: Set Field
Parameter 1: 1
Parameter 2: Title

Code Line Descriptor:

Number: 2
Method: Set Field
Parameter 1: 2
Parameter 2: Price

Code Line Descriptor:

Number: 3
Method: Set Field
Parameter 1: 3
Parameter 2: Author

The “Init Table Fields” method includes three code-line descriptors 35. The purpose of the method is to initialize the table's fields (columns), so that the table will contain three columns: the first will be the “Title”, the second “Price” and the third “Author”. This table will contain records, each of them holding details on a single book. The fields are configured accordingly.

Each of the code-lines when executed adds another field. For example, the first code-line calls the method “Set Field”, and through the parameters instructs the method to set the 1^{st} field to be labeled “Title”. Note that the “Set Field” method is not included in any class descriptor 32 shown here, since the method already exists in the “Table” class (which has been previously loaded).

The “My Application” class is generated similarly to the “My Table” class, although it has no parent. This means that the application class is purely generated. Note that “My Application” includes a property descriptor 36 called “Books Table”:

Property Decriptor:

Name: Books Table
Type: My Table

This Property will hold the actual table on which the operations will be performed.

“My Application” also contains the method “Run”, which has four code-line descriptors 35:

Method Descriptor:

Name: Run
ID: 1
Code Line Descriptor:

Number: 1
Method: Init Table Fields
Parameter 1: Books Table

Code Line Descriptor:

Number: 2
Method: Get Data From Server
Parameter 1: www.xyz.com/getdata%books
Parameter 2: Books Table

Code Line Descriptor:

Number: 3
Method: Sort Table By Field
Parameter 1: Books Table
Parameter 2: 2

Code Line Descriptor:

Number: 4
Method: Send Data To Server
Parameter 1: www.xyz.com/setdata%books
Parameter 2: Books Table

The first Code-Line calls the “My Table” method “Init Table Fields”, described earlier, in order to initialize the table property. The second code-line calls a system method that is not associated with any class, which generally gets data from server 150 and puts it into a property. Note that the provided parameters are a URL of the server from which the data is retrieved, and the target property—in this case “Books Table”.

The third code-line calls the “Sort Table By Field” method, which belongs to the “Table” class. The parameters instructs the method to sort the “Books Table” according to the second (Price) field.

The fourth Code-Line calls a system method that is not associated with any class, which generally sets or sends data to a server from a provided property.

Runtime engine 60 loads and generates these Classes, and for the generated classes runtime engine 60 also generates the Properties and Methods. For the loaded (including downloaded) classes, runtime engine generates properties (methods do not need to be generated because as mentioned above, the methods are hard-coded). The next step is execution. In this example, execution proceeds as follows. Runtime engine 60 retrieves the application class, in this case “My Application” from class repository. In this embodiment, runtime engine 60 looks for a generated class that contains a unique ID, indicating that this is the application's application class.

Then, Runtime engine 60 instantiates an object from the “My Application” class. Automatically all of the Properties of “My Application” are instantiated as well. So the new My Application Object will include a new instance of My Table, which is accessible through the Books Table Property.

After the “My Application” object has been initialized, runtime engine 60 invokes the Run Method. This results in the invocation of the four code-lines in “My Application”:

First, the “Init Table Fields” method is invoked, to initialize the table's columns. This results in

a. Setting the first field to Title

b. Setting the second field to Price

c. Setting the third field to Author

Second, runtime engine 60 requests data from server 150 according to the URL. When the data arrives, it is stored inside the “Books Table” object's property.

Third, the “Sort Table By Field” Method is called to sort the “Books Table” according to the 2^{nd} (Price) column.

Finally, after the table was sorted, runtime engine 60 calls the “Send Data To Server” method and sends the contents of the table to server 150 according to the URL.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

What is claimed is

1. A method for building at least part of an application dynamically, comprising the steps of:
providing a document including a specification for building at least part of an application; and
building said at least part of an application dynamically using said specification; wherein said at least part of an application is new and said building includes providing said at least part of an application.

2. The method of claim 1, wherein said document is written in semi-structure data.

3. The method of claim 2, wherein said document is written in an XML based language.

4. The method of claim 1, further comprising the step of:
launching an application including said at least part.

5. The method of claim 1, wherein said at least part of an application is a class and said specification is a class descriptor.

6. The method of claim 5, further comprising the steps of:
parsing said document; and
translating said parsed document into at least one class descriptor.

7. The method of claim 1, wherein said step of providing includes the step of:
creating said at least part of an application.

8. The method of claim 7, wherein said at least part of an application is a class, said specification is a class descriptor, and said step of creating includes the step of:
generating said class.

9. The method of claim 8, wherein said step of generating includes the steps of:
creating a new class; and
filling in class details into said new class, according to said class descriptor.

10. The method of claim 9, wherein said class descriptor includes at least one method descriptor; and said step of generating further includes the steps of:
for each method descriptor included in said class descriptor:
creating a new method; and
filling in method details into said method according to said method descriptor.

11. The method of claim 10, wherein said at least one method descriptor includes at least one code line descriptor, and said step of generating further includes the steps of:
for each code line descriptor:
creating a new code line; and
filling in code line details into said code line according to said code line descriptor.

12. The method of claim 9, wherein said class descriptor includes at least one property descriptor; and said step of generating further includes the steps of:
for each property descriptor included in said class descriptor:
creating a new property; and
filling in property details into said property according to said property descriptor.

13. The method of claim 5, wherein said class contains at least one other class.

14. The method of claim 13, wherein said class descriptor includes at least one property descriptor, and said at least one property descriptor describes said at least one other class.

15. The method of claim 13, wherein at least one of said at least one other class is generated.

16. The method of claim 13, wherein at least one of said at least one other class is loaded.

17. The method of claim 16, wherein said at least one of said at least one other class that is loaded was downloaded from a remote location.

18. The method of claim 16, wherein said at least one of said at least one other class that is loaded was an existing locally available class.

19. The method of claim 5, further comprising the step of:
instantiating an object from said class.

20. The method of claim 19, wherein said step of instantiating includes the steps of:
creating a new object;
associating said new object with said class; and
creating properties of said new object according to property descriptors included in said class descriptor.

21. The method of claim 1, wherein said step of providing a document includes the step of:
receiving said document via a network.

22. The method of claim 1, wherein said step of providing said at least part of an application includes the step of:
receiving said at least part via a network.

23. The method of claim 22, wherein said step of receiving includes the steps of:
detecting that said at least part is not available locally; and
downloading said at least part via said network.

24. The method of claim 23, wherein said at least part is a basic part.

25. A system for dynamically building at least part of an application, comprising:
a generator for extracting from a document a specification for building at least part of an application; and
a loader for dynamically building said at least part of an application based on said specification, wherein said at least part of an application is new and said building includes providing said at least part of an application.

26. The system of claim 25, further comprising:
a local registry for storing information about at least part of said at least part of an application.

27. The system of claim 26, further comprising:
a registrar for managing said registry.

28. The system of claim 25, further comprising:
a storage for providing at least part of said at least part of an application to said loader.

29. The system of claim 25, further comprising:
a repository for storing said at least part of an application when active.

30. The system of claim 25, further comprising:
a communication connection for receiving said document from a remote server.

31. The system of claim 30, wherein said communication connection is also used for receiving said at least part of an application.

32. The system of claim 25, wherein said at least part is a class, the system further comprising:
an object repository for storing an instantiated object of said class when active.

33. A method for building an application of interest, comprising the steps of:
receiving a document including a specification for at least part of an application, over a network; and
building the application of interest;
wherein said document allows the application of interest to be built without the transfer of an executable file of the application of interest over said network.

34. The method of claim 33, further comprising the step of:
receiving executables for parts of the application of interest in a set-up phase prior to said step of receiving a document.

35. The method of claim 34, wherein said executables received in said set-up phase are basic parts.

36. The method of claim 33, wherein said step of building includes the step of:
receiving executables for parts of the application of interest over said network.

37. The method of claim 36, wherein said executables are for basic new parts.

38. The method of claim 36, wherein said parts of the application of interest are classes.

39. The method of claim 33, wherein said step of building is accomplished with insignificant accompanying transfer over said network of executables for parts of the application of interest.

40. The method of claim 33, wherein the step of building includes the step of:
creating parts of the application of interest.

41. The method of claim 40, wherein said step of creating includes the step of:
generating classes.

42. A program storage device readable by machine, tangibly embodying a program of instructions executable by the machine to perform method steps for building at least part of an application dynamically, comprising the steps of:
providing a document including a specification for building at least part of an application; and
building said at least part of an application dynamically using said specification; wherein said at least part of an application is new and said building includes providing said at least part of an application.

43. A computer program product comprising a computer useable medium having computer readable program code embodied therein for building at least part of an application dynamically, the computer program product comprising:
computer readable program code for causing the computer to provide a document including a specification for building at least part of an application; and
computer readable program code for causing the computer to build said at least part of an application dynamically using said specification; wherein said at least part of an application is new and said building includes providing said at least part of an application.

44. A program storage device readable by machine, tangibly embodying a program of instructions executable by the machine to perform method steps for building an application of interest, comprising the steps of:
receiving a document including a specification for at least part of an application, over a network; and
building the application of interest;
wherein said document allows the application of interest to be built without the transfer of an executable file of the application of interest over said network.

45. A computer program product comprising a computer useable medium having computer readable program code embodied therein for building an application of interest, the computer program product comprising:
computer readable program code for causing the computer to receive a document including a specification for at least part of an application, over a network; and
computer readable program code for causing the computer to build the application of interest;
wherein said document allows the application of interest to be built without the transfer of an executable file of the application of interest over said network.

46. The method of claim 1, further comprising the preliminary step of a server sending said document.

47. The method of claim 25, further comprising a server for sending said document.

48. The method of claim 33, further comprising the preliminary step of a server sending said document.
